(19) United States
(12) Patent Application Publication
(10) Pub. No.: US 2024/0354609 A1
(43) Pub. Date: Oct. 24, 2024

(54) MODELING OF AI RULE-ENGINE BEHAVIOR IN QUANTUM COMPUTERS

(71) Applicant: AT&T Intellectual Property I, L.P., Atlanta, GA (US)

(72) Inventors: Mohammad Nikain, Atlanta, GA (US); Jiyuan Wang, Cumming, GA (US); Daniel Connolly, Suwanee, GA (US)

(73) Assignee: AT&T Intellectual Property I, L.P., Atlanta, GA (US)

(21) Appl. No.: 18/060,877

(22) Filed: Dec. 1, 2022

(51) Int. Cl. G06N 10/20; G06N 10/40

(52) U.S. Cl. CPC G06N 10/20; G06N 10/40

(57) ABSTRACT

Aspects of the subject disclosure may include, for example, identifying, by a processing system of a classical computer, a predetermined state of a communications system, the communications system managed by a rule engine implementing a plurality of rules in response to a set of state variables; providing, by the processing system, to a quantum computer, a set of Qbits corresponding to the predetermined state of the communications system; and receiving, by the processing system, from the quantum computer, a set of solution Qbits, the solution Qbits corresponding to one or more actions of the classical computer to place the communication system in a desired state from the predetermined state. Other embodiments are disclosed.

### FIELD OF THE DISCLOSURE

The subject disclosure relates to modeling of artificial intelligence rule-engine behavior in quantum computers.

### BACKGROUND

Quantum computing is widely expected to solve valuable problems that today's most powerful classical supercomputers cannot solve. Companies are investing in quantum computing for its expected benefits. However, there are limited solutions on how to apply these benefits to real world problems. In particular, there is no solution to applying quantum computing to an artificially intelligent rule engine.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates an exemplary, non-limiting embodiment of an inference engine in accordance with some aspects described herein.

FIG. 2C illustrates an exemplary, non-limiting embodiment of a quantum computer in accordance with some aspects described herein.

FIG. 2D illustrates an exemplary, non-limiting embodiment of a quantum computer illustrating connections between rule gates and the second circuit of FIG. 2C in accordance with some aspects described herein.

FIG. 2E through FIG. 2H depict an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for defining a predetermined state of a system such as a communication system according to a set of state variables and converting the set of state variables to, first, a set of facts associated with the states of the system, and a set of actions that may be taken to move the system from the current predetermined state to a desired state. The facts are converted to Qbits for processing by a quantum computer. The quantum computer processes all possible action simultaneously and returns a solution that includes one or more actions to be taken by the classical computer that will move the system to the desired state.

Quantum computing is widely expected to solve valuable problems that today's most powerful classical supercomputers cannot solve. Companies are investing in quantum computing for its expected benefits. However, there are limited solutions on how to apply these benefits to real world problems. There is no solution to applying quantum computing to an artificially intelligent rule engine as described herein. We have found a way to practically leverage key quantum computing advantages in a rule-based AI engine. By using quantum computing, the speed of the rule engine can increase by several orders of magnitude and enable such engines to address significantly larger problems. Other embodiments are described in the subject disclosure.

One or more aspects of the subject disclosure include a device including a quantum computer and a classical computer in data communication with the quantum computer. Aspects of the disclosure further include the classical computer comprising a processing system including a processor and a memory that stores executable instructions that, when executed by the processing system, facilitate performance of operations. In aspects, the disclosure further includes defining a system by a set of state variables and a set of rules, the set of rules identifying a set of actions to be performed based on a present state of the set of state variables, the system having a desired state, providing information about the set of state variables and the set of rules to the quantum computer, and receiving information from the quantum computer, the information defining a set of required state variables, the set of required state variables determined by the quantum computer to put the system into the desired state.

One or more aspects of the subject disclosure include determining, by a classical computer, that a system is in a stuck state, the stuck state defined by a set of state variables that selectively trigger rules of a rule engine, identifying a desired state of the system, determining a first set of facts corresponding to the set of state variables, and determining a second set of facts corresponding to a set of possible actions to resolve the stuck state to the desired state of the system. Aspects of the subject disclosure further include determining a set of Qbits corresponding to the first set of facts and the second set of facts, providing the set of Qbits to a quantum computer, and receiving, at the classical computer from the quantum computer, a solution, the solution corresponding to one or more correct actions to take to achieve the desired state of the system.

One or more aspects of the subject disclosure include identifying, by a processing system of a classical computer, a predetermined state of a communications system, the communications system managed by a rule engine implementing a plurality of rules in response to a set of state variables, providing, by the processing system, to a quantum computer, a set of Qbits corresponding to the predetermined state of the communications system; and receiving, by the processing system, from the quantum computer, a set of solution Qbits, the solution Qbits corresponding to one or more actions of the classical computer to place the communication system in a desired state from the predetermined state.

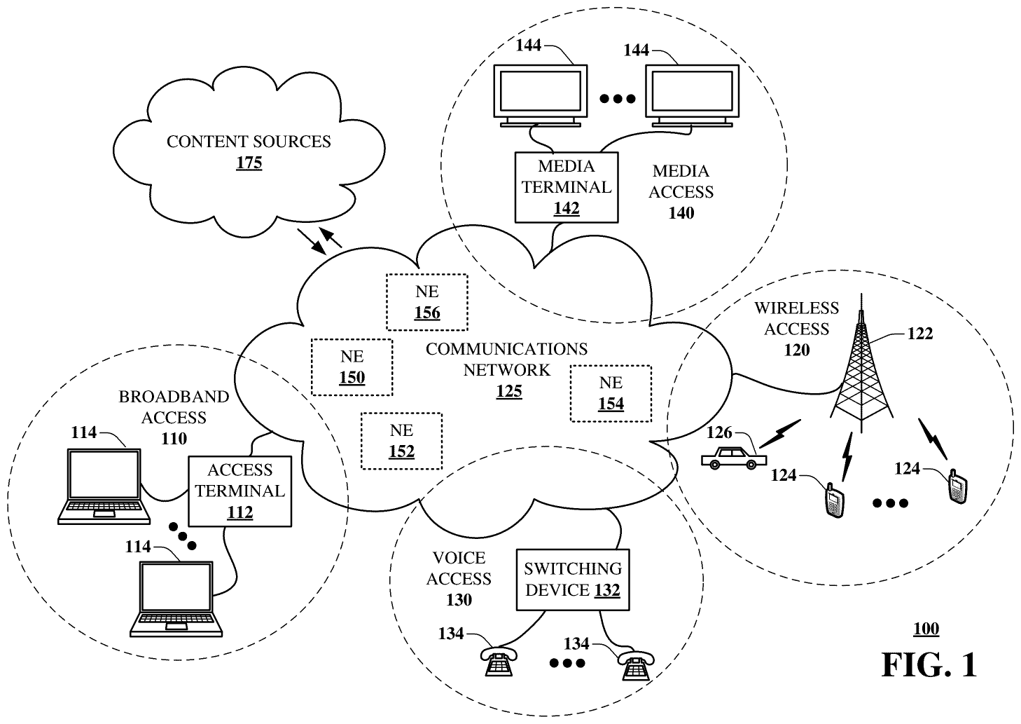

Referring now to FIG. 1, a block diagram is shown illustrating an example, non-limiting embodiment of a system 100 in accordance with various aspects described herein. For example, system 100 can facilitate in whole or in part a process of defining a state of a system as a set of state variables and rules that control aspects of operation of the system, as well as actions to be performed by components of the system, and providing the information to a quantum computer for identification of a solution to move the state of the system to a desired state. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

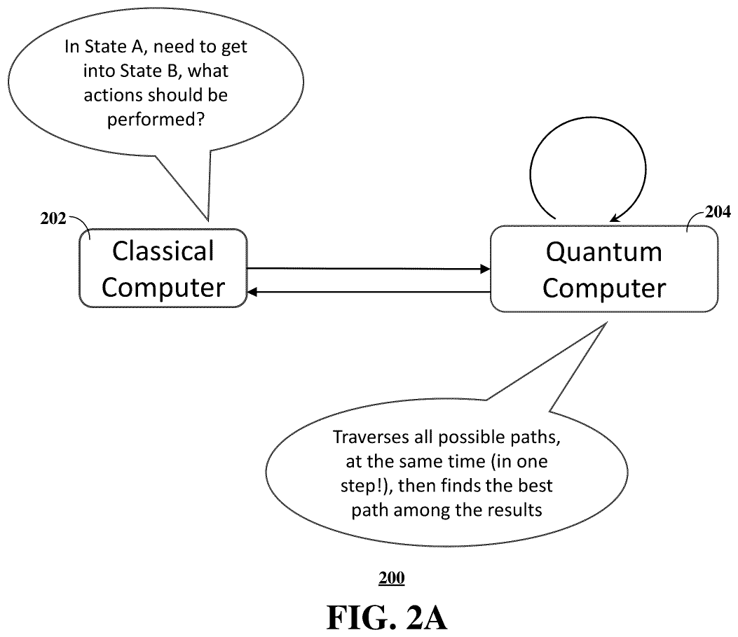

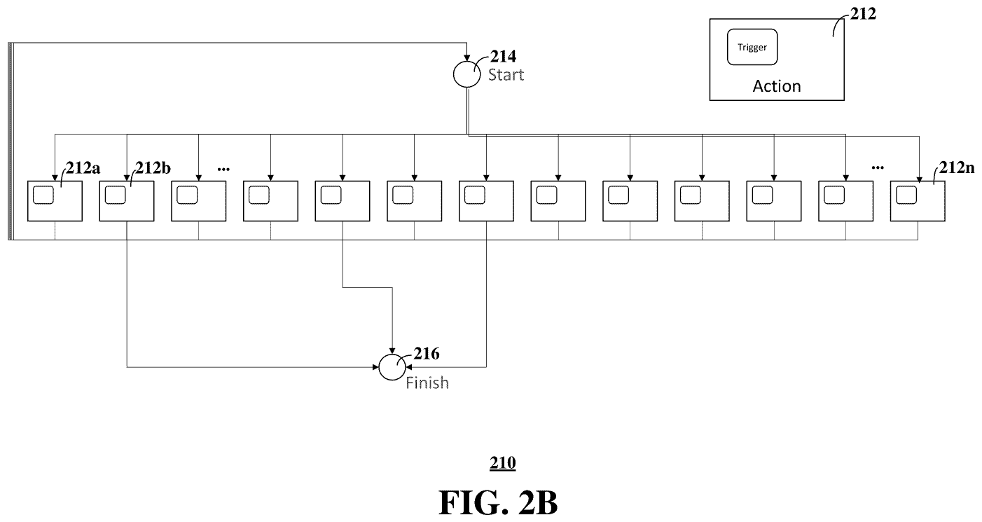

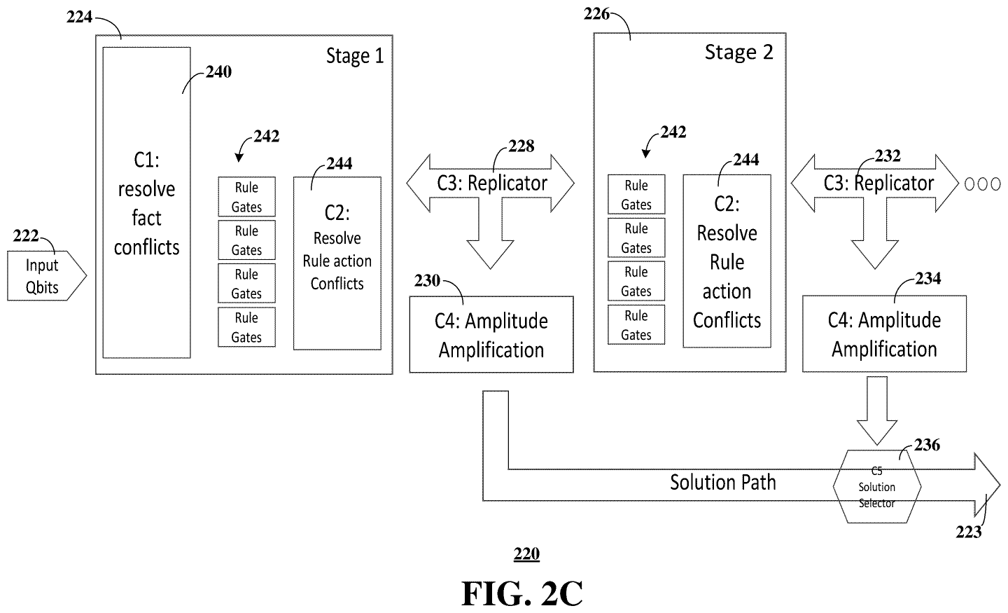

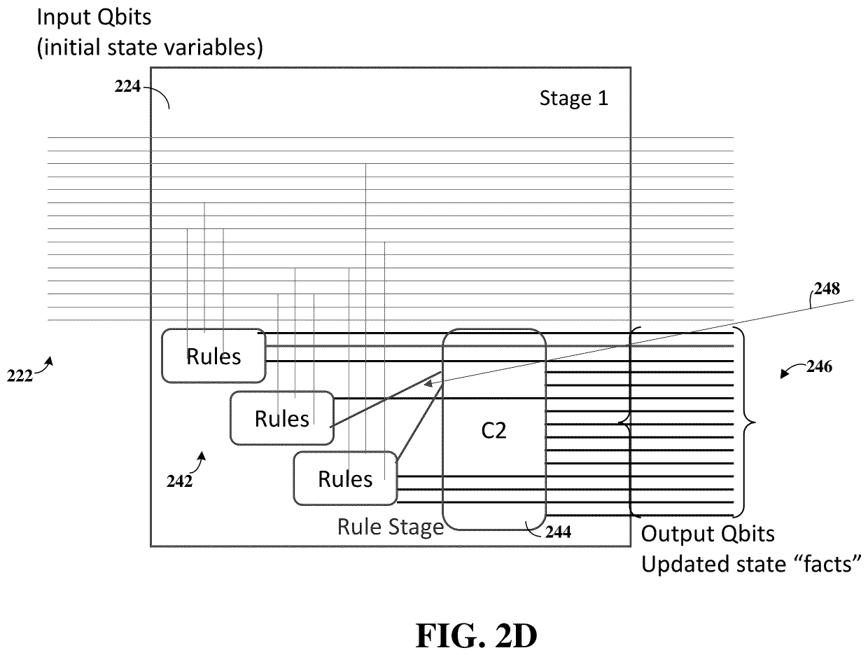

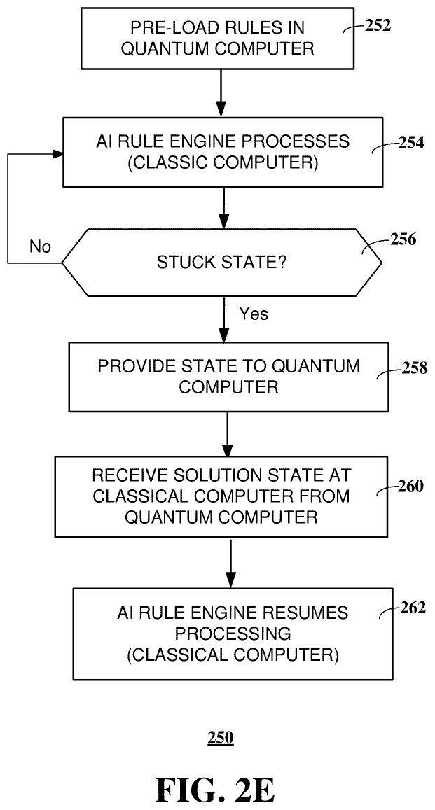

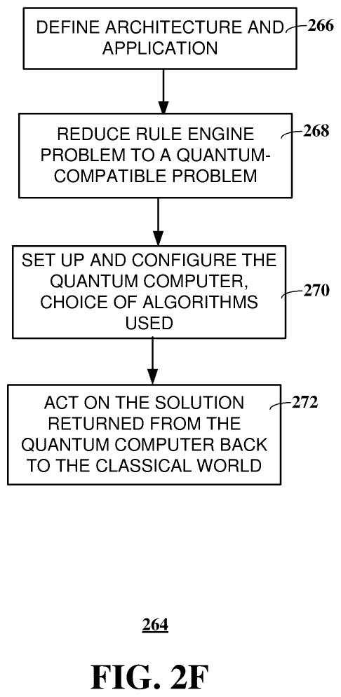

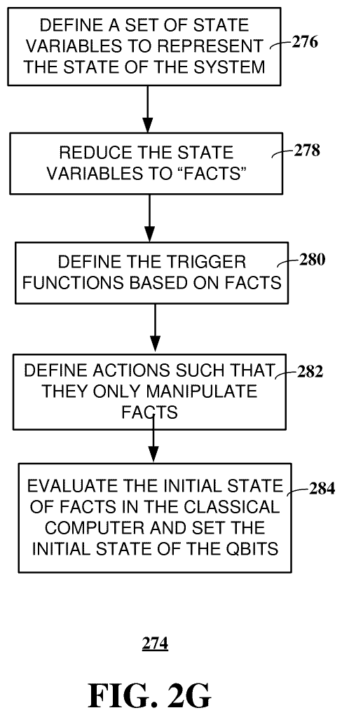

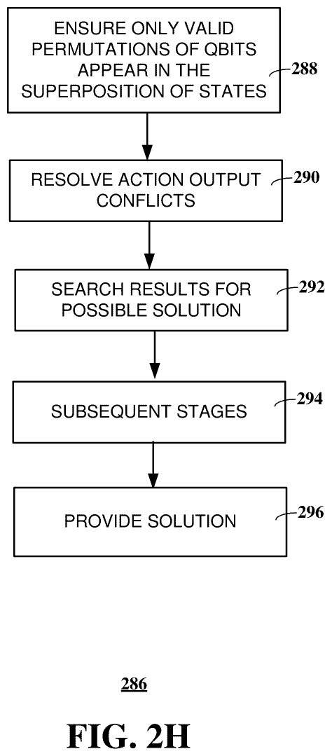

FIG. 2A is a block diagram illustrating an example, non-limiting embodiment of a system 200 functioning within the communication network of FIG. 1 in accordance with various aspects described herein. The exemplary system 200 includes a classical computer 202 interacting with a quantum computer 204.

The classical computer 202 generally includes a processing system including one or more processors and memory. The memory stores data and instructions. The one or more processors access the instructions and data to perform operations. The classical computer 202 may be implemented in any suitable fashion.

In particular embodiments, the classical computer 202 implements an artificial intelligence (AI) system. The AI system may include a machine learning model and an inference engine or rule engine. The classical computer 202 generally receives input data from an input source or memory, processes the data to a result and produces output data or some action.

The quantum computer 204 implements a process of computation using quantum circuits or quantum logic gates. The quantum computer 204 makes use of properties such as quantum superposition and quantum entanglement. In quantum superposition, a bit may exist as a zero or one at the same time. Any two or more quantum states can be added together or superposed and the result will be another valid quantum state. A quantum computer can do a calculation on a bit as if the bit was zero and one and produces both results at the same time. At the instant of measurement of the result, the quantum computer collapses into a correct answer or more appropriately, into a probabilistic answer or range of answers. Conversely, every quantum state can be represented as the sum of two or more distinct states. The superposition conditions of quantum computing carry with them information that is not available with classical computers.

In quantum computing, entanglement refers to a property in which a quantum state cannot be factored as a product of its constituents. One constituent cannot be fully described without considering the others. A product of two two-bit numbers can have any of four values, probabilistically. However, once one of the three values, factors or product, is measured or known with certainty, the other two values are also known with certainty, because they are all entangled. Once one of the entangled values is observed, the others will be consistent with that observation. The consistency is called entanglement.

Quantum computers use Qbits or qubits as their inputs and outputs and use quantum gates as their logical processing units. Rule engines use working memory entities (WMEs) as their inputs and outputs and rules as their processing units. While there are conventional methods to convert WMEs into Qbits, and rules into quantum gates, such conventional techniques fall short on two areas. First, such conventional methods they require a similar number of Qbits as classical bits in a classical computer. While using gigabits of memory in a classical computer is routine, having even 1 Kb of Qbits is presently considered state of the art in quantum computing. So, a solution having giga-Qbits device is not only decades away, due to the complexity of materializing Qbits, it will be cost prohibitive when it arrives. Second, conventional methods for converting WMEs into Qbits do not readily take advantage of properties such as superposition and entanglement, which are some of the main two benefits of quantum computing. Thus, conventional methods are impractical, too expensive, and essentially provide no benefit. This is apparent from a current lack of such a system despite current advances in quantum computing.

In some embodiments in accordance with various aspects described herein, the system 200 may be used in conjunction with a specific case of problems that may be encountered in many network situations. In some embodiments, the classical computer 202 implements a rule-based system such as a rule engine or an inference engine.

FIG. 2B illustrates a rule engine or inference engine 210 in accordance with some aspects described herein. The inference engine includes a plurality of rules 212, indicated as rule 212a, rule 212b . . . rule 212n. The number of rules may be chosen arbitrarily depending on the nature of the system including the inference engine and the task to be accomplished by the inference engine. The inference engine operates on data called a working memory entity (WME). Rules are defined and operate on WMEs. The rules may be described as if→then statements. In general, the statement evaluates some condition on the WMEs. The rule 212 triggers on the left-hand side (LHS) of the rule statement. The right-hand side (RHS) of the if→then statement provides an action to be performed. The RHS of the rule 212 provides an action to be performed if the trigger is true.

In general, the inference engine 210 performs a constant evaluation of trigger conditions of each rule 212a, 212b, . . . 212n. A current state 214 is defined by, for example, a set of state variables. Each rule 212a, 212b, . . . 212n responds to current values of the state variables of the current state 214 to produce a next state. At each iteration, one or more rules 212a, 212b, . . . 212n may fire. When a rule fires, the LHS test returns a true value which causes the RHS action to be performed. The inference engine performs the actions, e.g., the RHS or if→then, defined by each rule 212 according to the existing state variables and the trigger of the rule. The changes that these actions cause, in turn, trigger other rules on the next cycle, and the cycles continue. At some point, no rules will trigger, hence there are no actions, and hence the machine stops, or acquiesces, and the operation is considered complete. A final state 216 is thus obtained. In some applications, the operation never completes, for example, if external factors can update WMEs and trigger more rules. Both modes are typical depending on the application. The inference engine 210 may further include a set of optimizations and ancillary functions that optimize how triggers are evaluated, prevent multiple firing on the same condition, aid in tracking and debugging, and other functions.

In examples, the triggers or LHS conditions may be a list of conditions of the WMEs. Some typical examples include
machineType=“router” and “region”=“eastern”
errorCount>200
CPUusage>90%

The action defined by the RHS can be any suitable action to be performed upon a true condition of the LHS. Some typical examples include
Reboot the machine
Generate an alarm.

The exemplary problem arises in, for example, network management systems in which a variety of data inputs and system inputs are received, and a variety of devices must be controlled according to an operational program or plan of action. Such situations are very typical in operational support systems (OSS) for telecommunications networks (such as communications network 125 of FIG. 1) and for network provisioning and fault management. However, the general problem is also encountered in many other situations, including situations in which an inference engine or rule engine is employed.

In accordance with the general problem, the network system is at a current state. The specific, current state may be perhaps an unfamiliar state. Examples of such a current state include a situation where a network fault just occurred, or where provisioning a customer account ran into a problem, or where a change order has arrived, etc. In the example of a rule-based system such as a system using an AI engine or a rule engine, there are a set of state variables that are tested using rules. In an example, a rule-based system has a set of state variables that define the current state of the system. Examples include port provisioning, yes or no; is a provisioning order new, yes or no; does the customer have good credit, yes or no. These are specific examples from a telecommunication system; similar examples apply to any similarly managed system. Generally, the system is defined by a set of state variables that define the current state of the system, which may be unfamiliar or even undefined. Based on that current state, the system needs to resume operation in a controlled and defined manner, according to the rules of the rule engine.

In a conventional, process-oriented system, a process would be defined from start to end, perhaps including a series or sequence of steps to be performed. The steps may be based on inputs, such as current state variables. The steps may be conditional such as if→then statements or repetitive, looping statements that test a condition.

In a rule engine, each rule operates independently to test a condition and produce a result. Each rule fires at a particular time under a particular circumstance. When the trigger or test of LHS is true, the action of the RHS is performed. The inputs are a set of state variables. When a state variable changes, a rule may fire. If a rule fires, it may cause other state variables to change. That, in turn, will cause other rules to fire. The rule engine generally operates in this manner.

Further, generally, a goal of the operational management system is to get the system to a desired state. Examples may include a state with a current fault resolved, or with provisioning complete for a customer. As noted, the system is governed by a set of rules which may be quite complicated. For example, any update made by action of a rule affects many things, and those affect other things in turn. Some of the variables in the system can be manipulated, some cannot. Still further, updating the system parameters or state variables, such as by taking an action according to a rule, will set into motion a series of complex changes which eventually settle the system in a different state. The new state may be the desired state or a different state, including possibly a worse state.

One issue to be resolved is, given the desired state and the and the rules in the system, determining what values should the current variables be set to in order to arrive at the desired state after firing the rules. The variables that can be changed are, in effect, the controls that are available. Only a subset of the system parameters may be updated by the user. For example, by controlling one or more state variables, the user can reset a machine, update network settings, etc. However, merely by controlling the available state variables, the user or the system cannot produce the final, desired state, such as getting the system error count to zero, or getting the received-good-packet count to go to a nominal value. While the desired state is known in advance, which parameters to update, and to what values, is not known for the current state. Further, determining such information to achieve the desired state is extremely difficult in a system of substantial size, with many variables and many rules.

A possible solution may be implemented using a classical computer such as classical computer 202. The classical computer 202 may be programmed to simulate all different conditions and permutations and then determine which one obtains the desired state. Each permutation includes a different combination of values for all state variables in the system The classical computer 202 would try each permutation in order and wait for the system to settle, after all affected rules fire and all state variables change. If the state to which the system settles for that permutation is not the desired state, the permutation is rejected and another permutation tested. Such a simulation can be impractical if the system uses more than a few state variables.

The quantum computer 204 may be used in conjunction with the classical computer 202 to address and solve the problem. In some embodiments, a quantum computer such as quantum computer 204 may be used to determine which parameters should be updated and to what values. The quantum computer operates to try all combinations simultaneously and may repeat the process a few times to address events that need to occur in sequence. This may be done, on average, on the order of the logarithm of the number of rules involved.

Such a solution provides many distinct advantages. The solution provides a practical set of steps or simplifications, including an algorithm, to effectively reduce system parameters (WMEs in a classical AI framework) into facts, and then convert facts into Qbits. Further, the solution provides an algorithm and procedure to convert a rule, including its two main components, namely the trigger or LHS and the action or RHS statements, into a structure that can be implemented on Qbits using quantum gates. Still further, the solution describes how quantum computing properties of superposition and entanglement can be fully leveraged when these algorithms are used.

In particular, the solution in accordance with aspects described herein addresses the case where certain rules or events must happen sequentially. Such cases are a major issue for superposition, since it makes everything happen at once. The solution, therefore, takes a complex problem and allows it to be implemented using a minimal number of Qbits, and hence practical for use in quantum computers available within the foreseeable future, and taking full advantage of the features of a quantum computer.

FIG. 2C illustrates an exemplary, non-limiting embodiment of a quantum computer 220 in accordance with some aspects described herein. In the embodiment of FIG. 2C, the quantum computer 220 includes an input 222, a first stage 224, a second stage 226, a first replicator 228, a first amplitude amplification stage 230, a second replicator 232, a second amplitude amplification stage 234, an output selector 236 and an output 223. The first stage 224 includes a first circuit 240, one or more rule gates 242 and a second circuit 244. Similarly, the second stage 226 includes one or more rule gates 242 and a second circuit 244. Other embodiments may include additional, fewer or alternate components. The features of the quantum computer 220 may be formed in any suitable manner from any suitable materials and devices.

In a general embodiment, the first stage 224 of the quantum computer 220 may receive one or more Qbits at the input 222 and operate on the input Qbits. In a simple example, the first stage 224 may receive two 3-bit input values. The input values will be multiplied to form a 6-bit value. By virtue of superposition, the input will have all possible 3-bit values and the output will have all possible 6-bit values. However, once the output value is measured, it will collapse to a true value and the two input values will collapse as well, by virtue of the entanglement principle. If it is desired to determine what input values will give an output value of 15 (decimal), the multiplication operation can be repeated several times and the output measured. When the desired output value of 15 is measured, the entangled input values collapse to an input value of 3 and an input value of 5. The input values and the output values will be consistent, even though they are random or probabilistic in nature. Thus, to obtain an output value of 15, it is known that the input values of 3 and 5 must be provided to the first stage 224.

In a particular embodiment, the input 222 receives input information defining the current state condition for a system. The input information received at the input 222 may be a multibit or multi-Qbit value. In an example, a first subset of the Qbits forming the input information may be dependent on the state of the system. An example is a number of bits that correspond to the number of subscribers to communication service in a communications network. The first subset of bits are fixed or cannot be manipulated or controlled. A second subset of the Qbits forming the input information may be selectable by a user or may be specified to define a state or condition of the system. An example is Qbits defining a reset of a portion of the communication network or a software update that has been made to another portion of the communication network. The second subset of bits can thus be manipulated.

In the embodiment, all bits corresponding to the system state may be communicated to the input 222 of the quantum computer 220 at the same time. In this example, the input bits that can be controlled or manipulated are provided to the input 222 in superposition. In effect, this provides all possible solutions to the system at the same time.

Upon receipt of the input bits at the input 222, the rule gates 242 trigger on the input bits. Since all input combinations are sent at the same time, in superposition, all combinations of the output are produced by the rule gates 242 at the same time. One of the combinations is the desired solution for the system.

The rule gates 242 operate to implement in the quantum computer 220 the rules defined for the system in an implementation such as is shown in FIG. 2B of an inference engine 210. The rules of the inference engine 210 may be embodied as quantum rule gates in the quantum computer 220.

The first circuit 240 operates to combine the states of the input information received at the input 222. This operates to disallow unwanted states. If any bit combinations remain which are not allowed, they are distributed over the remaining states with equal probability as to essentially erase them from existence. Other techniques may be used to handle unwanted states. For example, alternatively, the first circuit can be wired or otherwise placed in data communication with the second circuit 244 to disallow any rules of the rule gates 242 that may act on non-allowed combinations or states.

The second circuit 244 operates to resolve conflicts among actions of the rules of the rule gates 242. The second circuit operates to remove invalid states on the output of the quantum computer 220. In combination with the first circuit 240, the output of the first stage 224 will contain only valid outputs. As a result, subsequent stages such as second stage 226 do not need to replicate the functionality of the first circuit 240 and first circuit 240 is omitted from subsequent stages.

The first replicator 228 replicates output Qbits from the first stage 224. Qbits generally need to be physically replicated to be sent to two destinations and this circuit performs that task. Any suitable replication technique or circuit may be used.

The first amplitude amplification stage 230 implements an algorithm called Grover's algorithm. Grover's algorithm may also be referred to as the quantum search algorithm. Grover's algorithm is a quantum algorithm for unstructured search that finds with high probability the input to a black box function that produces a particular output value, using a reduced number of evaluations of the black box function. The algorithm can be used to speed up algorithms such as search functions. The stage formed by the first stage 224 is used as an oracle and a sequence of stages including the second stage 226 is used to achieve amplification to the stage deemed sufficient for the application. Any suitable circuit or technique can be used to implement the first amplitude amplification stage 230.

The first amplitude amplification stage 230 further operates to amplify amplitude of the output information from the first circuit 240. By amplifying the amplitude, the probability is increased of obtaining the desired output. In the example of FIG. 2C, the desired output is known, but the inputs required to obtain the desired output are unknown. Thus, the first amplitude amplification stage 230 operates to increase the probability of determining the output of the first stage 224 and therefore effectively identifies the input required to form that output.

FIG. 2D illustrates an exemplary, non-limiting embodiment of a quantum computer 220 illustrating connections between rule gates and the second circuit of FIG. 2C in accordance with some aspects described herein. In the embodiment of FIG. 2D, the first stage 224 includes an input and an output. In the example, the input 222 is a multi-Qbit input and the output 246 a multi-Qbit output. Each rule gate 242 is wired to the input 222 and the output 246. Under each permutation of input information or states, a set of rules of the rule gates 242 will fire.

In general, it is not good practice, and may be considered a defect in logic, for multiple rules of the rule gates 242 that activate on the same state of the system to update the same facts. Therefore, there is no overwriting conflict. That is, each rule updates different facts for each permutation. Even though all permutations occur at the same time in superposition, the rule outputs are entangled with that particular permutation and hence only act in that particular universe of outcome and hence there is no overwriting. So, in the above cases, the main function of the second circuit 244 is to passively combine the outputs of each rule gate 242 onto the same output fact or Qbit of the output 246.

As an exception, users may actually desire indeterministic behavior by the system by having conflicting rules, indicated in the drawing figure by the line 248. This may be desired to display randomness or variety, for example, in outcomes. In the classical case, this will resolve by the infinitesimal delays in actual trigger times which essentially determine which rule or rule gate 242 will win. But in the quantum case, this may interfere with superposition and consistency of the Qbit states. Therefore, the second circuit 244 operates to combine the outputs in a deterministic way using priorities or other criteria established among the rules to ensure there is a hierarchy which determines which rule will actually update the Qbit of the output 246 if multiple rules fire on the output at the same time.

In the embodiment of FIG. 2C, the quantum computer 220 includes a second stage 226 and provision for more stages. Additional stages may be connected in a sequence or series of stages. Associated with the second stage 226 is a second replicator 232 and a second amplitude amplification stage 234. Multiple stages may be desirable in some implementations. When the rule gates 242 are active, they will fire simultaneously and change outputs. Changing outputs may cause other rules to fire and change yet other outputs in subsequent stages. Using multiple stages allows the quantum computer to cycle through several iterations to find the correct solution. This is operationally comparable to a looping operation, though looping is generally not possible for the quantum computer 220.

The output selector 236 operates to combine inputs from the first stage 224 and the second stage 226. The output selector 236 determines if the input received from the first stage 224 contains the desired results. If the input from the first stage 224 does contain the desired results, the output selector passes it through to the output 223. If the input from the first stage 224 does not contain the desired results, the output selector will ignore the input and pass the input from the second stage 116 to the output 223 of the quantum computer 204 as the desired state for the inference engine of the classical computer.

In embodiments, the quantum computer 220 may provide a set of solution Qbits to the classical computer. Each solution Qbit, or group of Qbits, corresponds to one or more actions to be taken to move the system from the stuck state to the desired state. Thus one solution Qbit or set of Qbits may correspond to an action of reordering a residential gateway; a second solution Qbit or set of Qbits may correspond to an action of scheduling delivery of the residential gateway to customer premises; a third solution Qbit or set of Qbits may correspond to scheduling service personnel to install the residential gateway according to the scheduled delivery; a fourth solution Qbit or set of Qbits may correspond to reconfiguring a customer account to reflect the installed residential gateway and any other changes. The classical computer coverts the solution Qbits to predefined actions. In embodiments, the predefined actions are associated with the solution Qbits at the time the system state is reduced to facts and associated with Qbits, such as during processing of method 274, FIG. 2G.

Thus, the quantum computer 220 operates to receive a set of state variables. Rules fire on the state variables and produce another state. The amplitude is amplified to find the desired condition and the quantum computer 220 determines if the desired state is present. If the desired state is not present, the quantum computer continues looking at the new state. The quantum computer continues processing until the desired state is present.

Referring again to FIG. 2A, the classical computer 202 operates in conjunction with the quantum computer 204. The classical computer 202 may be part of a system of any level of complexity, such as a telecommunications network or a group of such networks, such as communications network 125 of FIG. 1 The classical computer 202 and the quantum computer 204 are in data communication over any suitable network. Any suitable transformation of data may be made to enable communication between bits used by the classical computer 202 and the Qbits used by the quantum computer 204.

In a first step, the classical computer 202 formulates a problem, reduces it to facts, and sends information to the quantum computer 204 for resolution. Formulation of the problem may include formulating rules, determining the current situation and developing a set of bits or Qbits. For example, if a number of customers can be between 0 and 1000, the classical computer 202 allocates 10 bits for that information. If a port can be reset in five different ways, the classical computer 202 allocates 3 bits for that information. Some bits may be set to 1 or 0 depending on the current state of the system. Some bits may be controllable by the classical computer 202. In embodiments, the controllable bits are in superposition when provided to and processed by the quantum computer 204. The classical computer 202 defines a multi-bit output value corresponding to the current state of the system. In an example, the classical computer may send as input information a 50-bit value corresponding to the system state. Twenty of the 50 bits are set according to existing system state and not controllable. Thirty of the 50 bits are controllable by the classical computer and should be processed in superposition by the quantum computer 204. The classical computer communicates the output value to the quantum computer 204.

In a second step, the quantum computer 204 receives the input information in superposition and tries all the solutions at the same time and calculates all possible outcomes in a single step. The quantum computer 204 simulates all the rules specified for the system by the classical computer 202. The rule building process may be a pre-processing step between the classical computer 202 and the quantum computer 204 or may be done during run time as part of the information conveyed to the quantum computer 204 by the classical computer 202. In a third step, the quantum computer 204 uses Grover's algorithm, or any suitable equivalent, to amplify the results of the correct solution. The quantum computer 204 may run as many cycles, using as many stages, as necessary to determine a satisfactory solution.

In a fourth step, the quantum computer 204 returns to the classical computer information defining the correct set of actions to perform to place the system in the desired state. The quantum computer 204 provides information defining the controls the classical computer must instantiate for the rules to effectively produce the correct results. In the example above, the quantum computer 204 returns 30 bits that are controllable by the classical computer with the message or implication that the values provided by the quantum computer are the values to use to put the system in the desired state. The classical computer 202 may parse the 30 bits and modify the state of the system accordingly.

FIG. 2E depicts an illustrative embodiment of a method 250 in accordance with various aspects described herein. The method 250 may be used as part of a data processing system for managing any suitable system. In an example, the system to be managed includes one or more telecommunications networks in which equipment of a service provide provides data communications to remotely located subscribers. The method 250 may be implemented in any suitable processing system such as a computer with management or supervisory functions in the telecommunications network or other system. The method may be initiated in any suitable manner, such as by activating the supervisory function. In the illustrated embodiment, the method is performed on a classical computer such as a computer having a Von Neumann architecture. The classical computer cooperates with a quantum computer, similar to the example of FIG. 2A. Further, the classical computer implements an artificial intelligence (AI) rule engine to provide the supervisory function for the system.

At step 252, the classical computer pre-loads rules in the quantum computer. As noted, the classical computer implements an AI rule engine. The rule engine implements and tests a set of rules for controlling a process, such as is illustrated in FIG. 2B. In step 252, some or all of the rules used by the AI rule engine are provided to the quantum computer. In particular embodiments, the rules may be converted to a form usable by the quantum computer. Any suitable data transformation may be applied for communicating information between the classical computer and the quantum computer.

At step 254, the AI rule engine, operating on the classical computer, processes data in a conventional manner. Data may include information about current states of the system, components of the system and functions of the system. Processing may include applying current state information to one or more AI rules. Each rule constantly evaluates a designated trigger condition. At each iteration of the AI rule engine, one or more rules might trigger. Triggering of a rule corresponds to a defined trigger condition of the rule (the left-hand side or LHS) evaluating as TRUE and causing the action defined by the rule (the right-hand side or RHS) to activate.

At step 256, the method 250 determines if the AI rule engine enters a stuck state. More generally, step 256 determines if the system is at a specific and possibly unfamiliar or undefined state. In examples, a stuck state may occur when a network fault has just occurred, or provisioning a customer's account ran into a problem, or a change order has arrived. Any predetermined criteria may be used to define the stuck state. In the extreme case, the rule engine is unable to proceed or make additional progress. In other cases, a state variable has an undefined value that makes continued processing problematic or impossible. The stuck state may arise because an unexpected state has occurred which was not anticipated by design of the rules of the rule engine, such as a particular unanticipated network fault. If the current state matches the predetermined criteria, the rule engine, or a supervisory process for the rule engine operating on the classical computer, may determine at step 256 the rule engine is in a stuck state. If no stuck state is identified, processing continues as normal at step 254. The classical computer may operate in a loop including step 254 and step 256 without interruption for an indeterminate time period. If a stuck state is identified, control proceeds to step 258.

At step 258, the classical computer provides information about the current state to the quantum computer. The classical computer may provide any suitable information to the quantum computer. For example, the classical computer may provide information about one or more particular state variables that are determined to be part of the stuck state. In embodiments, the information may be provided as a multi-bit value in which each bit has a particular, predefined significance and value. Some of the bits may be defined by components or processes of the system, such as a number of computer ports available to the system or the current number of subscribers in the telecommunications network. Other bits may be controllable by the classical computer, such as information about server computers that can be added to the system to vary network configuration. Information conveyed to the quantum computer may correspond in part to a desired state of the system. The desired state of the system may be a known, controlled, expected state which will allow the system and the rule engine to proceed in an expected manner.

In some embodiments, the classical computer operates to perform set of steps or simplifications of an algorithm to modify or reduce system parameters. Such system parameters may be working memory entities (WMEs) in a classical AI rule engine or other framework into facts, and then as facts into Qbits for processing by the quantum computer. Further, the classical computer may implement algorithm to convert a rule, with its two main components, namely the trigger or LHS and action or RHS statements, into a structure that can be implemented on Qbits using quantum gates.

In response to receiving the information about the current state, the quantum computer operates to determine which parameters should be updated and to what values. The quantum computer may do that by trying all combinations simultaneously and repeating the process a few times to address events that need to occur in sequence. The quantum computer relies on quantum principles of superposition and entanglement. In particular, the quantum computer may address a situation where certain rules or events must happen sequentially in the system under control of the rules engine. This is one major consideration for superposition, since the principle of superposition makes everything happen at once. The solution, therefore, takes a complex problem and allows it to be implemented using a minimal number of Qbits while taking full advantage of the features of a quantum computer.

At step 260, the solution determined by the quantum computer is received by the classical computer. The solution may have any suitable format, such as a multibit value in which each bit and the value of each bit has a predetermined significance or meaning. In embodiments, the solution corresponds to a state in which the classical computer should be placed in order to get to the desired state.

At step 262, after application of the solution from the quantum computer to return the classical computer to the desired state, the classical computer resumes processing. For example, the rule engine may resume receiving state variables and applying predefined rules. In some embodiments, one or more rules may be added or modified by the classical computer, based at least in part on the solution determined by and provided by the quantum computer.

FIG. 2F depicts an illustrative embodiment of a method 264 in accordance with various aspects described herein. The method 264 is an embodiment of a method for interaction between a classical computer and a quantum computer to resolve a problem in an overall system, in accordance, for example, with the system 200 of FIG. 2A.

At step 266, the method 264 includes a process of defining overall architecture of a problem and a solution and application of quantum computers to rule-engines implemented in classical computers. Step 266 may include a process of selecting a problem type. For example, the overall state of the system may be described by a set of state variables, or more precisely, a set of state “facts.” In the system and the rule engine, then, each permutation of values of the state variables uniquely defines a unique state of the system.

Further, consistent with the rule-engine implementation, a finite set of rules identify which actions in the system are triggered. The rules evaluate all or some of the state variables, and generally only the state variables, for the triggering decision. In the rule engine design, actions update the value of state variables based on the action logic. The action logic may or may not use the then current state. The impact of the action is defined through the updates that are made to the state variables by the action and value of other state variables.

Step 266 may further include operations to define the problem in the classical computer. If a problem is not already in the above form, then steps should be taken to ensure the problem meets the above criteria.

Step 268 may include one or more procedures for reducing a classic rule-engine problem to a quantum compatible problem. More detail about embodiments implementing step 268 is provided in conjunction with FIG. 2G.

Step 270 may include procedures to set up and configure aspects of the quantum computer and the selection of algorithms to use to resolve the problem. More detail about embodiments implementing step 270 is provided in conjunction with FIG. 2H.

Finally, step 272 may include procedures of receiving the solution back at the classical computer, along with methods of acting on the solution returned from the quantum computer back into the classical world.

FIG. 2G depicts an illustrative embodiment of a method 274 in accordance with various aspects described herein. Method 274 includes aspects of embodiments to perform step 270 of method 264 illustrated in FIG. 2F. In some embodiments, the steps of method 274 may be performed manually by a human to complete some or each step. In other embodiments, the steps of method 274 may be performed automatically by a suitable data processing system such as classical computer 202 (FIG. 2A), or by a combination of human effort assisted by processing power.

Method 274 may be described in conjunction with an exemplary use case involving provisioning of equipment for a customer or subscriber of a communications network. The process includes selecting and designating equipment such as a residential gateway required for providing a service to the customer, shipping the equipment to the customer site, scheduling personnel, installing and troubleshooting the equipment by the personnel and confirming the service. Such a process involves business support systems (BSS) for functions such as customer validation, billing, etc. Such a process further involves workforce management for functions such as installation and testing of equipment. The example may involve installing customer equipment for a passive optical network (GPON) at the customer's premises to provide optical fiber to the premises. The process involves many separate steps including setting up static or dynamic IP addresses, setting up a firewall, delivery of network equipment, scheduling of installation personnel over one or more visits to the customer premises, and other steps. The exact nature and function of steps are not key. However, the number of elements and relationships that must be in place, in a preferred or required sequence, in order to establish the service for the customer, is substantial.

In the example, the customer service is partially provisioned, and then some aspect of the process fails or changes which disrupts the provisioning process. Examples of disruptions may include a supplement or amendment to the customer's order. Such a change requires that the system determine what was changed and what remains the same, what steps of the process need to be cancelled, what steps of the process need to be modified, and what steps of the process remains to be completed. The system must assess the change, determine the impacts, and take the necessary step to get the process back on track, automatically without operator intervention. In this example, the order for the new service might encounter a problem; some of the components or processes that require preliminary setup might not be in place or might not have required capacity. Some other components might fail to be installed or provisioned properly and cause other process failures, etc. Further, during these conditions, the process may continue using conflicting information, which further complicates the unknown aspects of the process and conflicts in the configuration state.

Conventionally, order supplements or amendments of this nature typically invoke complex and expensive procedures to implement. Empirically, such supplements and amendments may account for sixty percent of overall development cost. Due to their complexity, in some cases, they may not be fully implemented. Many cases must rely on expensive manual process to address problems. Any changes in network technology, service type, etc., can impact overall network operations.

At step 276, a set of state variables are designed to conclusively represent the state of the system. The state variables may relate to aspects of the overall system or procedure. The state variables can have values such as binary or numerical values. An example is a state variable for “residential gateway shipped to the customer site.” This state value can have values of 0 or 1, true or false, completed or not. Another example is an identifier for a virtual local area network (VLAN) installed at the customer site. The VLAN ID has a numerical value that can be represented as a state variable.

In an example, all relevant information for the system is converted to a set of one or more bits representing the state variable. A true or false state variable may be converted to a single bit. A numerical value such as the VLAN ID may be converted to a sufficient number of bits to represent the identifier. The pattern may be extended to other types of data and other types of state variables as well.

At step 278, the method 274 includes a process of reducing the state variables to a set of facts. This may be done in any suitable fashion, depending on, for example, the nature of the state variables and the process being implemented. For example, if the primary usage of the state variable is to compare the state variable against thresholds, then define a fact for each threshold crossing e.g.,

$$Fact 1 = a < 5 ( \text{true:} a < 5 , \text{false:} a \geq 5 ) .$$

In another example, if the value is an enumeration type, then break the number of enumerations into bits, and use a combination of facts to represent the value; e.g., state=Alabama; there are 50 states (corresponding to 6 bits)=>Fact1-Fact6:
FFFFFF=Alabama, FFFFFT=Alaska, etc.

Or, enumeration or categorical state variables may be turned into facts using multiple bits. For information about an optical network terminator (ONT), [ONT state] splits into 3 facts, each can be true or false:
[ONT state=ready], [ONT state=installed], [ONT state=ordered]

In another example, actions (further defined in step 280) may set a variable to a value. The actual value may not matter if only ranges of values are used in trigger functions. And therefore, it might be sufficient to define a fact for each range and have the action set the facts as true or false based on the results. This may be used to the extent possible.

In another example, if certain facts are mutually exclusive or interdependent, combine them and produce a set of mutually independent facts. For example, three facts: x<5, x>5, x=5 may be reduced to two facts

$$( TT = x < 5 , TF = x > 5 , FT = x = 5 , FF not used )$$

If other reductions of a state variable to a fact can apply, then the state variable may be represented by its binary representation. For example, the state variable may be modeled by many facts
(bit0 of binary x is set, bit1 or x is set, bit2 of x is set, etc.)

In embodiments, such representations of state variables should be minimized since it may adversely affect system efficiency.

In step 278, the current state of the system may be represented with these facts. Each fact corresponds to a Qbit in the quantum computer and can be true or false.

At step 280, trigger functions may be designed based on the facts developed at step 278. For example, each fact may be either true or false. Therefore, the trigger function (LHS) is just a Boolean combination of these facts. In another example, if certain facts always appear together in a trigger function, an attempt should be made to combine them into aggregate facts. Any suitable method may be used to reduce these facts into aggregate facts. Note that this may be subject to limitations posed on the action section associated with the facts.

Step 280 may further include an operation to reduce possible actions into facts. At any situation, certain actions are possible. These actions are set off by doing something. This can be reduced to updating an additional set of variables. For example, an operation to reset a residential gateway during installation at the customer premises this can be initiated by setting a variable called “reset RG” to true. A process monitors this variable, and as soon as the state of the variable changes, the process operates to reset the residential gateway and hence set the residential gateway state variables to some known set of values.

A set of facts may be defined which will trigger actions similar to the example above. The facts may be either implicit or explicit. Examples of implicit actions include actions such as Reassign VLAN, allocate port, delete connection, etc. These facts are set to true and the result is that a process will start, perform a function, and as a result, update some of the state variables. In this case, the variable representing the action is simply set to true, corresponding to triggering the action. Explicit actions can also include just setting a state variable directly into a number. For example, set RG VLAN ID to the value 64.

At step 282, actions are defined such that they only manipulate facts. Actions perform tasks. However, these tasks must be modeled as updates to state variables. If an action performs multiple changes, such as resetting a port, then its entire impact on state variables or facts must be implemented. This may be further reduced to setting facts true or false based on simplifications such as in step 278 and to the extent possible. Any aggregation and definition of facts may take into account updates that the actions make and ensure there are sufficient fact variations available for the action to be performed.

At step 284, the initial set of facts are evaluated in the classical computer and used to set the initial state of the Qbits. At this point, there has been defined a set of states, step 278, which are partially known, along with a set of actions, step 280, which are generally unknown. The set of actions is to be identified as the correct set of actions to take to resolve the current problem. Step 284 establishes the requirements for the quantum computer. A quantum computer is required with one Qbit for each of the facts in step 278 and step 280. The Qbits corresponding to actions of step 280 are in superposition. The quantum computer will try all actions of step 280 at the same time to see if one of the actions gives the desired result.

FIG. 2H depicts an illustrative embodiment of a method 286 in accordance with various aspects described herein. The method 286 defines the internal configuration and operation of a quantum computer such as the quantum computer 204 of FIG. 2A. Method 286 may be considered along with the exemplary embodiment of a quantum computer 220 depicted in FIG. 2C.

The quantum computer tries all the solutions at the same time and calculates all possible outcomes in one step. For this to be possible, the entire workflow, the traditional approach, is broken down into a set of disjoint rules. In order to display artificial intelligence behavior, these rules need to break down into very small components, each one considering a few facts and taking a few actions. This breakdown should be done effectively, resulting in a large number of simple rules that display AI behavior. The effective breakdown results in many rules, interactions of which are not exactly predictable. The question becomes, which actions resolve the issue? Further, of those actions, which action does it more quickly and more effectively? This essentially means, what values are assigned to the facts of step 280?

The quantum computer will process all combinations of actions at the same time by virtue of the superposition principle. The actions will activate all the rules in all combinations and produce all the results. The results are new state variables, essentially the new values for step 278. Since the quantum computer processes all input combinations at the same time, all the output combinations will be provided at the same time also. However, because of the quantum nature, they are all mixed up in superposition. The challenge now is to separate out the correct answer from the wrong answers. The final processes separate out the correct answer, and then trace it back to the correct set of actions, step 280. Therefore, the system will know which actions to take to fix the issue.

In step 288, the quantum computer ensures that only valid permutations of Qbits appear in the superposition of states. In the example of FIG. 2C, this may be performed by the first circuit 240. A preliminary aspect of this step is handled by combining or aggregating related values, such as in step 282 of FIG. 2G. However, there might still be fact combinations that are not allowed in input. In the cases where some inputs are not allowed, a conflict resolution circuit is added to resolve the situation. This first circuit 240 further combines Qbits to reduce unallowed states, and then randomly distributes the disallowed states into corresponding valid combinations.

At step 290, the method 286 includes resolving action output conflicts. As shown in the exemplary quantum circuit arrangement of FIG. 2D, the outputs of the rule gates 242 are wired to the output facts, output 246. There is a need to properly combine the outputs from these rule gates 242 into the overall output of the stage 224. This combination is handled by the second circuit 244. There are superposition and entanglement implications along with other complications. The second circuit 244 removes invalid states on the output in combination with the first circuit 240. The output of the stage 224 will contain only valid outputs.

At step 292, the method 286 includes searching the results for a possible solution. After step 290, a set of outputs is ready which may or may not contain the desired solution. In the exemplary embodiment of FIG. 2C, the first amplitude amplification stage 230 performs amplitude amplification according to Grover's algorithm to amplify the desired state to look for the solution. If the first amplitude amplification stage 230 finds a solution, it will report it and complete the process.

The exemplary embodiment of FIG. 2C includes a first stage 224 and one or more subsequent stages including second stage 226. In some applications, the output of the first stage 224 will be fed into another stage, stage 226, and the process of evaluating the rule gates and resolving the rule action conflicts will be repeated. Since quantum computing does not currently provide a looping mechanism, there are only a predetermined maximum set of stages that can be used. Each stage is connected to two circuits. The second replicator 232 replicates the output and feeds it into the second amplitude amplification stage 234 and the subsequent stage, if any.

At step 296, a solution is provided by the quantum computer to the classical computer. Generally, the solution will be provided by the first replicator 228, the second replicator 232 or a replicator of another stage. In the event that one of the replicators does find the solution, the solution needs to be returned as the solution to the problem. Since it is not known a priori which stage produces a solution, the solutions from all stages need to be collected and then selectively switched on or off based on whether a solution is found. This operation may be performed by the solution selector or output selector 236.

The use of multiple stages corresponds to a need to execute rules sequentially to obtain a desired result. An effort should be made to reduce this need to sequentially execute the rules. Therefore, it is possible to reduce the maximum number of stages through an improved or more efficient design. However, this is not always possible and hence some applications may need more stages than other applications.

At step 296, the solution may be provided from the quantum computer to the classical computer. The solution may be provided in any suitable manner. In an example, the solution is provided as a multi-bit value with each bit having a predetermined definition and a predetermined value. The respective bits and bit values define actions to be taken to place the system in the desired state. For example, the fifth least significant bit may have values of 0 or 1. Value 0 corresponds to an action of “do not reset the port.” Value 0 may correspond to an action of “reset the port having the following identifier,” and the four least significant bits in the multi-bit value correspond to the four-bit identifier of the port to be reset.

The classical computer may take action based on the multi-bit solution. The action may be taken automatically by the classical computer, such as resetting the identified bit in the example. The action may be taken by directing another device to take action, such as re-scheduling a visit by a service technician to the customer premises in conjunction with workforce management systems, or placing an order for additional or replacement equipment. For example, if a residential gateway device is required but has not been delivered, a device may be ordered automatically by the classical computer or another device operating in the system. Further, the action may be taken by providing an indication or message to a human operator, directing the operator to take some specified action, such as contacting the customer by telephone or text message to schedule a follow-up visit by a technician. Any other suitable actions or modifications may be made by the classical computer in response to the solution provided by the quantum computer. Further, any suitable translations may be made to convert information from Qbits used by the quantum computer to bits used by the classical computer.

While for purposes of simplicity of explanation, the respective processes are shown and described as a series of blocks in FIG. 2E, FIG. 2F, FIG. 2G and FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The system of FIG. 2A and the methods of FIG. 2E, FIG. 2F, FIG. 2G and FIG. 2H allow an AI system such as a rule engine to leverage the tremendous power of quantum computers in predicting the system outcomes and hence determining the best next step or action in solving a complex problem. Behavior of an AI rule-based system is difficult to model and the complexity grows exponentially with the number of rules and state-variables. At some level, predicting this behavior and determining which input yields the desired results becomes effectively impossible with classical computers. The solutions illustrated and described herein allow a quantum computer to make such predictions and therefore provide the AI system with capabilities not currently possible, or extremely cost prohibitive.

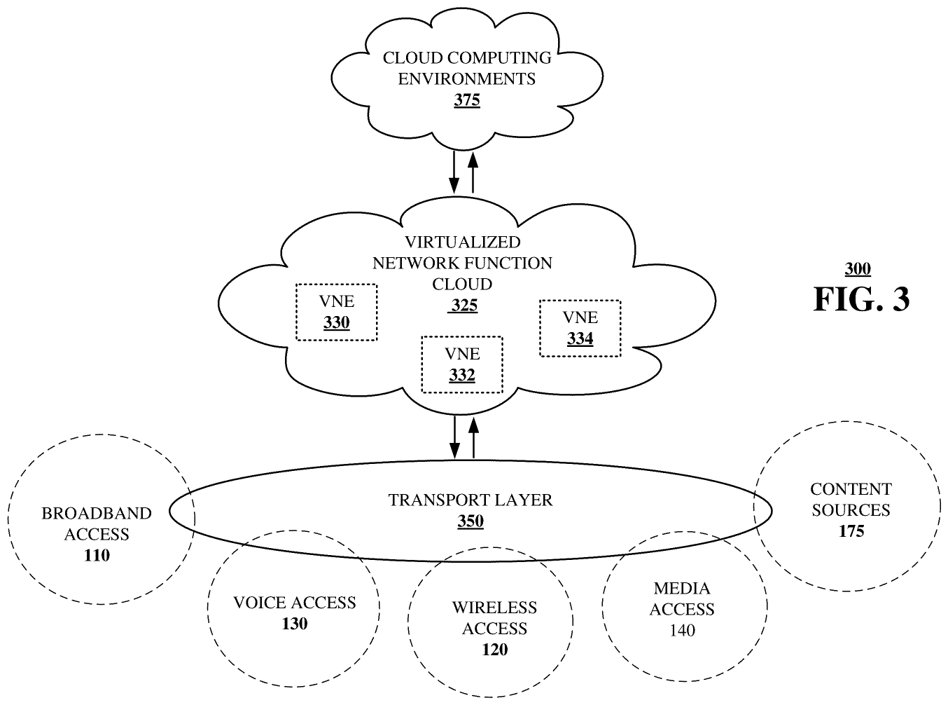

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 250, method 264, method 274 or method 286 presented in FIG. 1, FIG. 2A, FIG. 2B, FIG. 2C, FIG. 2D, FIG. 2E, FIG. 2F, FIG. 2G, FIGS. 2H and 3. For example, virtualized communication network 300 can facilitate in whole or in part defining a state of a system such as the virtualized communication network 300 as a set of state variables and rules that control aspects of operation of the virtualized communication network 300 as well as actions to be performed by components of the virtualized communication network 300, and providing the information to a quantum computer for identification of a solution to move the state of the system to a desired state. For example, due to a system fault, the virtualized communication network 300 may be placed in an undefined state. The process and devices described in conjunction with FIGS. 2A through 2H may be applied to return the virtualized communication network 300 to a defined state.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall, which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

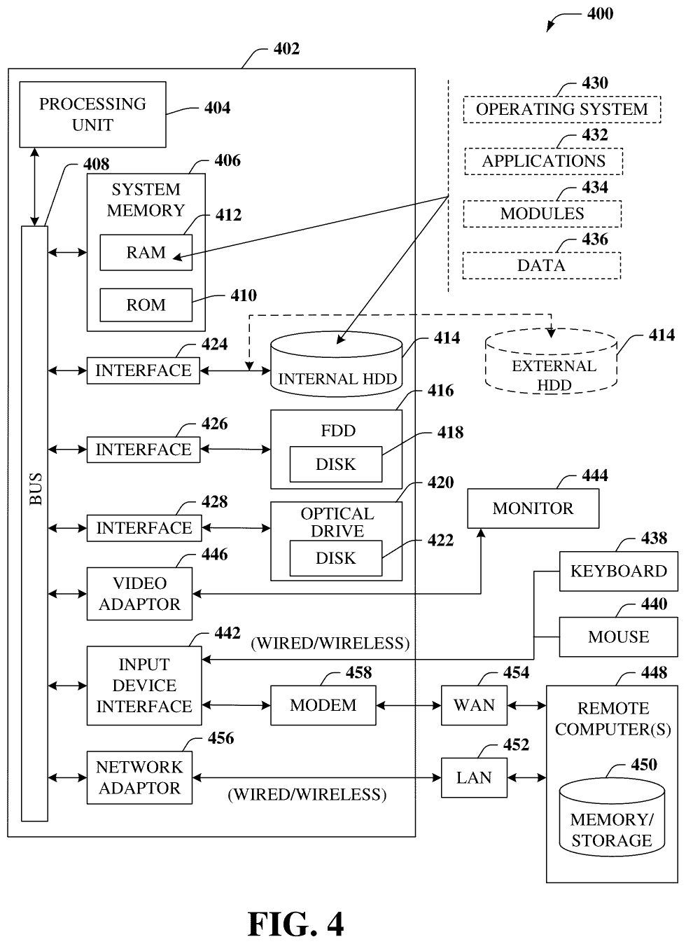

Turning now to FIG. 4, there is illustrated a block diagram of a computing environment 400 in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part defining a current state of a system on a classical computer, such as is represented by the computing environment 400. The current state and possible actions on the system may be converted to a set of facts and, in turn, converted to a set of Qbits for processing in a quantum computer. The quantum computer may return solution Qbits to the classical computer. The solution Qbits may define one or more actions to be taken by the classical computer to move the system to the desired state.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

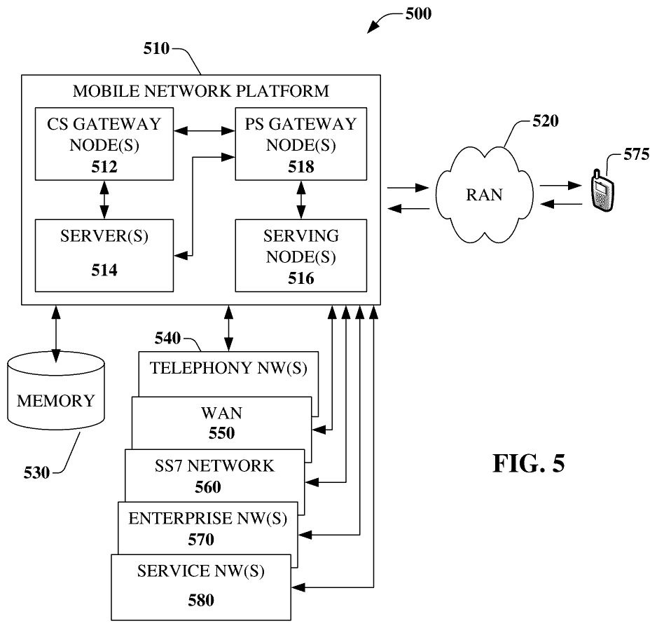

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part defining a state of a system such as the platform 510 as a set of state variables and rules that control aspects of operation of the platform 510 as well as actions to be performed by components of the platform 510 and providing the information to a quantum computer for identification of a solution to move the state of the system to a desired state. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

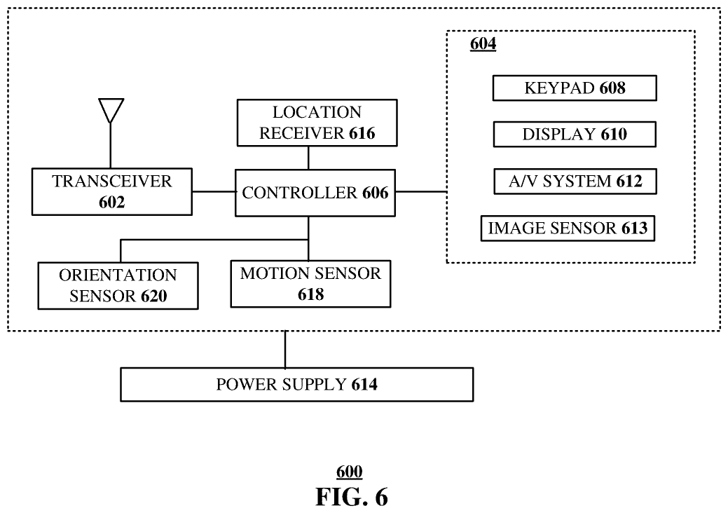

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part defining a current state of a system on a classical computer, such as is represented by the computing environment 400 of FIG. 4. The current state and possible actions on the system may be converted to a set of facts and, in turn, converted to a set of Qbits for processing in a quantum computer. The quantum computer may return solution Qbits to the classical computer. The solution Qbits may define one or more actions to be taken by the classical computer to move the system to the desired state.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a quantum computer;
a classical computer in data communication with the quantum computer, the classical computer comprising a processing system including a processor and a memory that stores executable instructions that, when executed by the processing system, facilitate performance of operations, the operations comprising:
defining a system by a set of state variables and a set of rules, the set of rules identifying a set of actions to be performed based on a present state of the set of state variables, the system having a desired state;
providing information about the set of state variables and the set of rules to the quantum computer; and
receiving information from the quantum computer, the information defining a set of required state variables, the set of required state variables determined by the quantum computer to put the system into the desired state.

2. The device of claim 1, wherein the operations further comprise:
reducing the set of state variables to a set of facts;
defining a set of trigger functions based on the set of facts;
defining the set of actions to be performed, each action of the set of actions manipulating one or more facts of the set of facts
evaluating the set of facts based on the set of trigger functions and the set of actions, forming an initial set of one or more Qbits; and
providing the initial set of one or more Qbits to the quantum computer for processing by the quantum computer.

3. The device of claim 2, wherein the providing the initial set of one or more Qbits to the quantum computer comprises:
providing a subset of the initial set of Qbits to the quantum computer in superposition, the subset of the initial set of Qbits defining a set of possible solutions, the subset of the initial set of Qbits to be processed by the quantum computer simultaneously to simultaneously produce all possible solutions of the set of solutions.

4. The device of claim 3, wherein the operations further comprise:
defining the subset of the initial set of Qbits based on the set of actions to be performed.

5. The device of claim 1, wherein the receiving information from the quantum computer defining a set of required state variables comprises:
receiving information defining state variables to be modified and values to which the state variables should be modified to attain the desired state.

6. The device of claim 5, wherein the operations further comprise:
modifying one or more components of the system according to the information defining state variables to be modified and values to which the state variables should be modified.

7. The device of claim 1, wherein the quantum computer comprises:
an input operative to receive an input value including a plurality of Qbits corresponding to the set of state variables and the set of rules; and
a first circuit configured to ensure that only valid permutations of Qbits are processed in the quantum computer.

8. The device of claim 7, wherein the quantum computer further comprises:
a plurality of quantum rule gates corresponding to rules of the set of rules to produce output values, each respective quantum rule gate producing a respective output value in response to the input value, the output values in quantum entanglement with the input value.

9. The device of claim 8, wherein quantum computer further comprises:
an amplitude amplification stage implementing Grover's algorithm to amplify the output values to thereby increase probability of finding a desired output value corresponding to the desired state.

10. The device of claim 9, wherein quantum computer further comprises:
a plurality of sequential stages, each stage of the plurality of sequential stages including a like plurality of quantum rule gates corresponding to rules of the set of rules to produce stage output values for each respective stage, the plurality of sequential stages for iterating to determine the desired output value corresponding to the desired state.

11. A non-transitory machine-readable medium, comprising executable instructions that, when executed by a processing system including a processor, facilitate performance of operations, the operations comprising:
determining, by a classical computer, that a system is in a stuck state, the stuck state defined by a set of state variables that selectively trigger rules of a rule engine;
identifying a desired state of the system;
determining a first set of facts corresponding to the set of state variables;
determining a second set of facts corresponding to a set of possible actions to resolve the stuck state to the desired state of the system;
determining a set of Qbits corresponding to the first set of facts and the second set of facts;
providing the set of Qbits to a quantum computer; and
receiving, at the classical computer from the quantum computer, a solution, the solution corresponding to one or more correct actions to take to achieve the desired state of the system.

12. The non-transitory machine-readable medium of claim 11, wherein the providing the set of Qbits to the quantum computer comprises:
providing a first subset of Qbits corresponding to the first set of facts; and
providing a second subset of Qbits corresponding to the second set of facts, wherein the providing a second subset of Qbits comprises providing the second subset of Qbits to the quantum computer in superposition to cause the quantum computer to test all possible actions of the set of possible actions simultaneously.

13. The non-transitory machine-readable medium of claim 11, wherein the operations further comprise:
defining a set of state variables which represent resources needed in the system, each state variable having a value;
converting the value to one or more facts of the first set of facts corresponding to the set of state variables; and
assigning a Qbit of the set a Qbits to the value, the Qbit having an assigned value of true or false.

14. The non-transitory machine-readable medium of claim 11, wherein the determining the second set of facts corresponding to the set of possible actions comprises:
defining a fact to include one or more variables which may be set to a predetermined state to trigger an action of the set of possible actions; and
defining a fact to have a value corresponding to a predetermined value of a state variable.

15. The non-transitory machine-readable medium of claim 11, wherein the operations further comprise:
modifying one or more components of the system according to one or more correct actions to take to achieve the desired state of the system.

16. The non-transitory machine-readable medium of claim 11, wherein the system comprises a communications system for providing communications to a plurality of subscribers and the operations further comprise:
identifying a network fault causing the stuck state;
receiving from the quantum computer a set of solution Qbits, the set of solution Qbits defining the one or more correct actions to take to achieve the desired state of the system;
converting the set of solution Qbits to a set of solution actions; and
performing, by the classical computer, the set of solution actions to correct the network fault.

17. A method, comprising:
identifying, by a processing system including a processor of a classical computer, a predetermined state of a communications system, the communications system managed by a rule engine implementing a plurality of rules in response to a set of state variables;
providing, by the processing system, to a quantum computer, a set of Qbits corresponding to the predetermined state of the communications system; and
receiving, by the processing system, from the quantum computer, a set of solution Qbits, the solution Qbits corresponding to one or more actions of the classical computer to place the communication system in a desired state from the predetermined state.

18. The method of claim 17, wherein the providing to the quantum computer the set of Qbits comprises:
providing, by the processing system, to the quantum computer, a first subset of Qbits corresponding to a set of states of the predetermined state; and
providing, by the processing system, to the quantum computer, a second subset of Qbits corresponding to a set of possible actions to change a state of the communications system from the predetermined state, wherein the providing the second subset of Qbits comprises providing the second subset of Qbits to the quantum computer in superposition.

19. The method of claim 17, comprising:
reducing, by the processing system, the predetermined state of the communications system to a first set of facts;
reducing, by the processing system, a set of actions to be taken to place the communications system in the desired state to a second set of facts; and
converting the first set of facts and the second set of facts to the set of Qbits corresponding to the predetermined state of the communications system.

20. The method of claim 17, comprising:
modifying, by the processing system, one or more components of the communication system according to the set of solution Qbits to place the communication system in the desired state.
